(19) United States
(12) Patent Application Publication
(10) Pub. No.: US 2019/0108317 A1
(43) Pub. Date: Apr. 11, 2019

(54) Method And System For Prescription Durable Medical Equipment Searching And Management

(71) Applicant: Nedich, Inc., Commerce Twp., MI (US)

(72) Inventor: Sasa NEDIC, Rochester Hills, MI (US)

(73) Assignee: Nedich, Inc., Commerce Twp., MI (US)

(21) Appl. No.: 15/730,378

(22) Filed: Oct. 11, 2017

(51) Int. Cl. G06F 19/00; G06F 17/30

(52) U.S. Cl. CPC G06F 19/3412; G06F 19/328; G06F 19/3456; G06F 17/30991; G06F 17/30867

(57) ABSTRACT

A method for durable medical equipment (DME) searching and management is disclosed. The method includes receiving input parameters corresponding to (i) a location, (ii) a DME product, and (iii) a DME provider. The method includes transmitting a query based on the input parameters. The method includes receiving a set of search results based on the query, and the set of search results includes at least one DME supplier and is generated based on a matching of the query and the at least one DME supplier. The method includes displaying the set of search results.

### FIELD

The present disclosure relates to a method and system for prescription durable medical equipment searching and management.

### BACKGROUND

This section provides background information related to the present disclosure which is not necessarily prior art.

After a patient receives a pharmaceutical prescription, a healthcare provider may generate and transmit an order for the prescribed medication to a pharmacy by, for example, sending the pharmaceutical prescription to the pharmacy. However, after a patient receives a new prescription for durable medical equipment/supplies and/or home medical equipment (referred to interchangeably herein as durable medical equipment), from the healthcare provider, unlike a pharmaceutical prescription, the patient often must seek out a durable medical equipment (DME) supplier. As such, it may be difficult for the patient to locate a durable medical equipment supplier that provides and/or sells the prescribed specific durable medical equipment (e.g., cochlear implant). Additionally or alternatively, the patient may not know whether certain durable medical equipment suppliers will accept the patient's private and/or federal health insurance. Furthermore, when the patient seeks a prescription refill of durable medical equipment (e.g., blood glucose measurement supplies), the patient may have to schedule an additional appointment with the healthcare provider in order to receive a prescription for a refill of the durable medical equipment.

### SUMMARY

This section provides a general summary of the disclosure, and is not a comprehensive disclosure of its full scope or all of its features.

The present teachings include systems and methods for durable medical equipment (DME) searching and management. The method includes receiving, using a processor that is configured to execute instructions stored in a non-transitory memory, input parameters corresponding to (i) a location, (ii) a DME product, and (iii) a DME provider. The method also includes transmitting, using the processor, a query based on the input parameters. The method also includes receiving, using the processor, a set of search results based on the query, wherein the set of search results includes at least one DME supplier and is generated based on a matching of the query and the at least one DME supplier. The method also includes displaying, using the processor, the set of search results.

The present teachings also include a system for durable medical equipment (DME) searching and management. The system includes a processor that is configured to execute instructions stored in a non-transitory memory. The instructions include receiving, using a processor that is configured to execute instructions stored in a non-transitory memory, input parameters corresponding to (i) a location, (ii) a DME product, and (iii) a DME provider. The instructions also include transmitting, using the processor, a query based on the input parameters. The instructions also include receiving, using the processor, a set of search results based on the query, wherein the set of search results includes at least one DME supplier and is generated based on a matching of the query and the at least one DME supplier. The instructions also include displaying, using the processor, the set of search results.

The present teachings also include a second system for durable medical equipment (DME) searching and management. The second system includes a processor that is configured to execute instructions stored in a non-transitory memory. The instructions include receiving, using the processor, a DME request, wherein the DME request is at least one of a prescription request and a prescription refill request, and wherein the DME request is generated by at least one of a patient profile, healthcare provider profile, and a case manager profile. The instructions also include identifying, using the processor, the patient profile associated with the DME request. The instructions also include generating, using the processor, a DME order based on the DME request and the patient profile associated with the DME request. The instructions also include generating, using the processor, a set of search results based on the DME order, wherein the set of search results includes at least one DME supplier from a list of DME suppliers, and the set of search results is based on at least one of (i) search parameters associated with the DME request, (ii) profile information associated with the patient profile, and (iii) a previous DME request associated with the patient profile. The instructions also include selecting, using the processor, a first DME supplier of the at least one DME supplier, wherein the first DME supplier is selected based on a matching of the first DME supplier and the DME order. The instructions also include transmitting, using the processor, the DME order to the first DME supplier.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an example healthcare management system according to the present disclosure.

FIGS. 2A-2D are illustrations of example software application states of the software application of the healthcare management system according to the present disclosure.

FIGS. 3A-3D are illustrations of example software application states of the software application for registered users of the healthcare management system according to the present disclosure.

FIG. 4 is a flowchart illustrating an example control algorithm of the durable medical equipment search system according to the present disclosure.

FIG. 5 is a flowchart illustrating an example control algorithm for generating prescriptions and prescription refills according to the present disclosure.

Corresponding reference numerals indicate corresponding parts throughout the several views of the drawings.

### DETAILED DESCRIPTION

Example embodiments will now be described more fully with reference to the accompanying drawings.

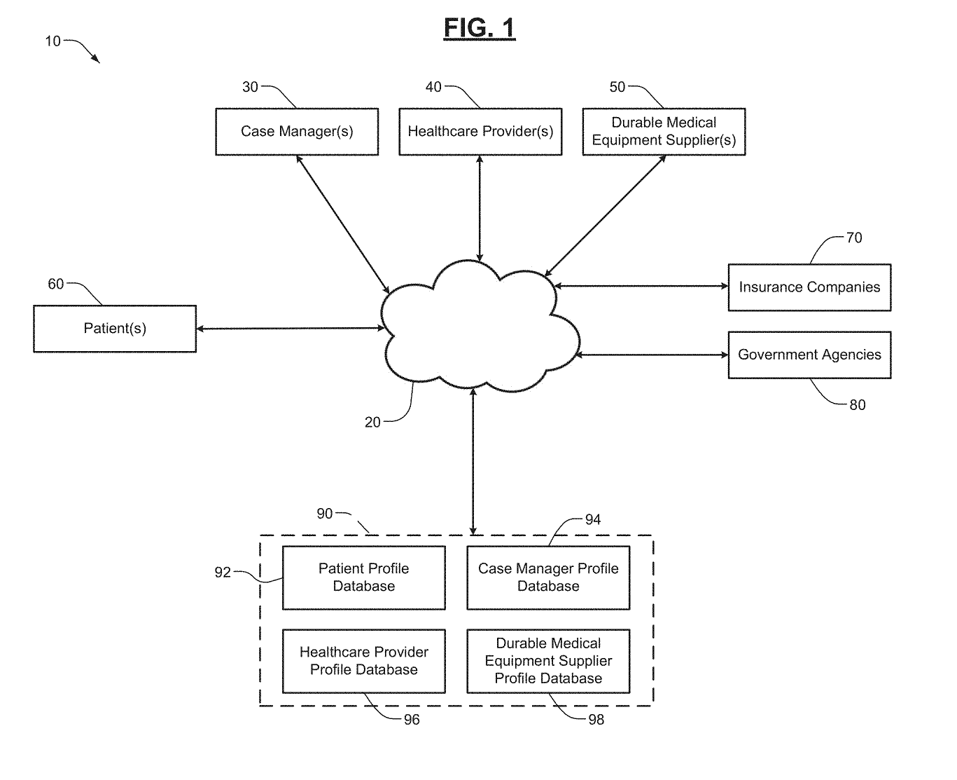

With reference to FIG. 1, an illustration of an example healthcare management system 10 is shown. The healthcare management system 10 may include various parties that are connected via a server 20. As an example, the healthcare management system 10 may include a case manager 30, a healthcare provider 40 (e.g., a physician), a durable medical equipment supplier 50, and a patient 60. Each of the case manager 30, healthcare provider 40, durable medical equipment supplier 50, and the patient 60 may access the healthcare management system 10 using a computing device, such as a mobile device. Alternatively, the case manager 30, healthcare provider 40, durable medical equipment supplier 50, and the patient 60 may use any other suitable computing device to access the healthcare management system 10, such as a desktop computer, laptop, PDA, or other similar device. Furthermore, the computing device may include a processor that is configured to execute instructions stored in a non-volatile computer-readable medium, such as read-only memory (ROM) and/or random-access memory (RAM).

Additionally, the healthcare management system 10 may be in communication with and receive information from insurance companies 70 and government agencies 80. This information may include, for example, what types of durable medical equipment and/or non-durable medical equipment are covered under the various private and/or federal health insurance plans.

Case managers 30, healthcare providers 40, durable medical equipment suppliers 50, and patients 60 that are a part of the healthcare management system 10 may each have a corresponding user profile stored on a memory 90 of the healthcare management system 10. As an example, the memory 90 may include a patient profile database 92, case manager profile database 94, a healthcare provider profile database 96, and a durable medical equipment supplier profile database 98. The memory 90 may be a non-volatile computer-readable medium, such as read-only memory (ROM) and/or random-access memory (RAM), which include instructions executable by a processor that is implemented by the server 20. The memory 90 may be included locally on the server 20 or, as shown in FIG. 1, may be remotely accessible by the server 20 via an LTE or other cellular data signal, Wi-Fi link, Bluetooth link, or other telemetric link.

The computing devices associated with the case manager 30, healthcare provider 40, durable medical equipment supplier 50, and the patient 60 may each include a software application (hereinafter “App”) that enables the computing devices to access the healthcare management system 10. The App is a software product that causes the computing device to perform a function. As an example, the functions of the App may be accessed using native application editions of the software and/or web applications of the software.

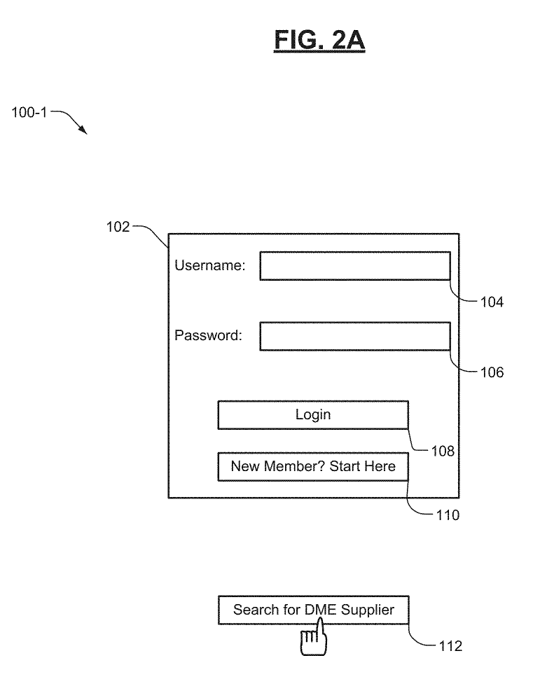

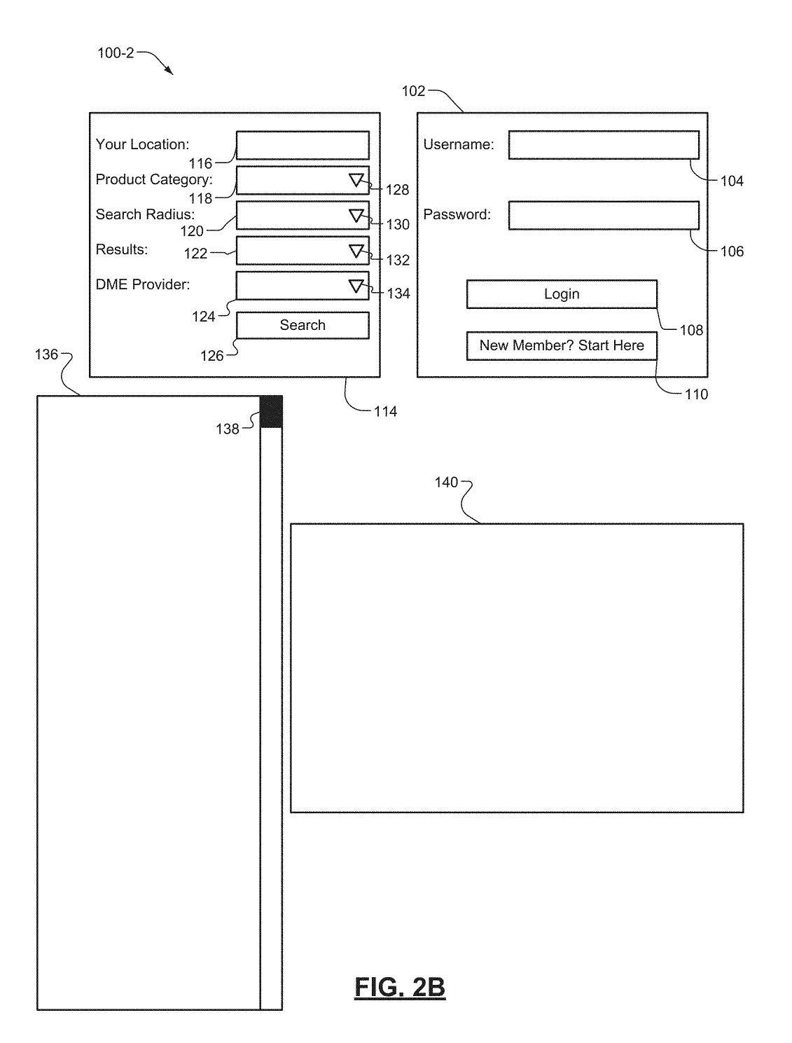

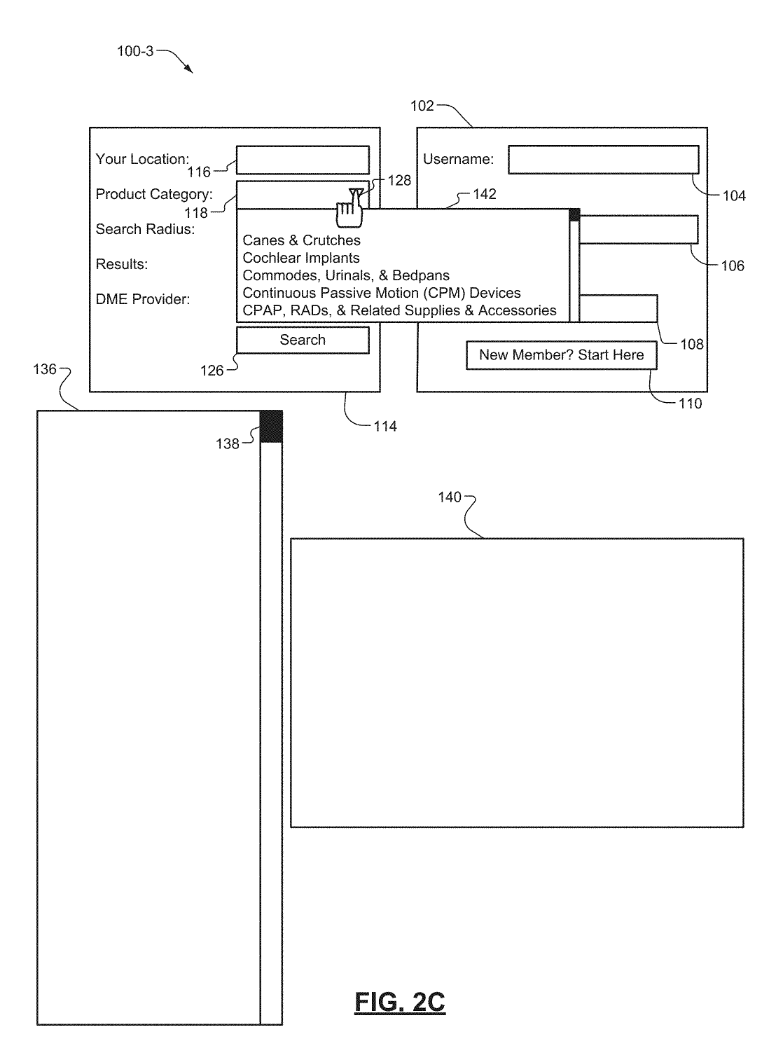

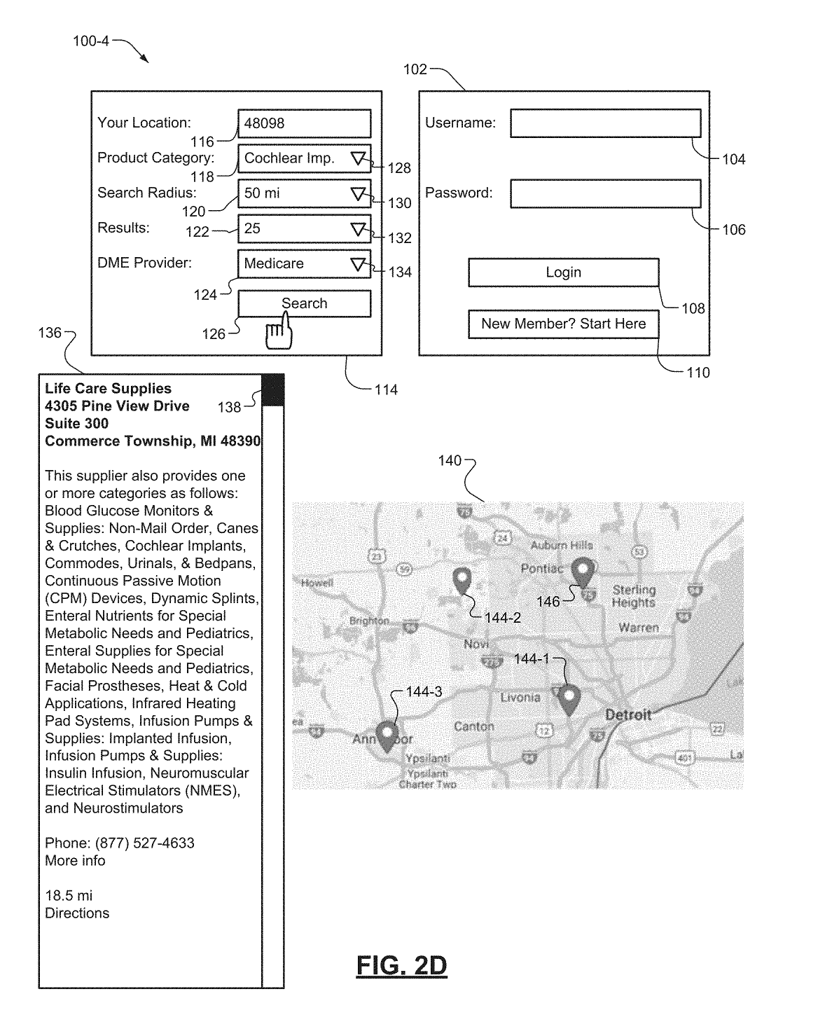

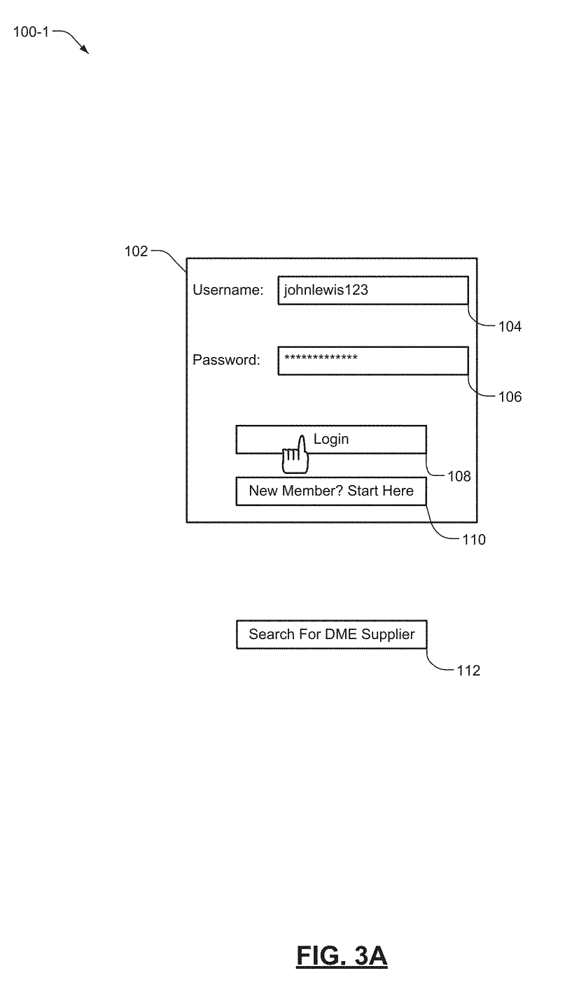

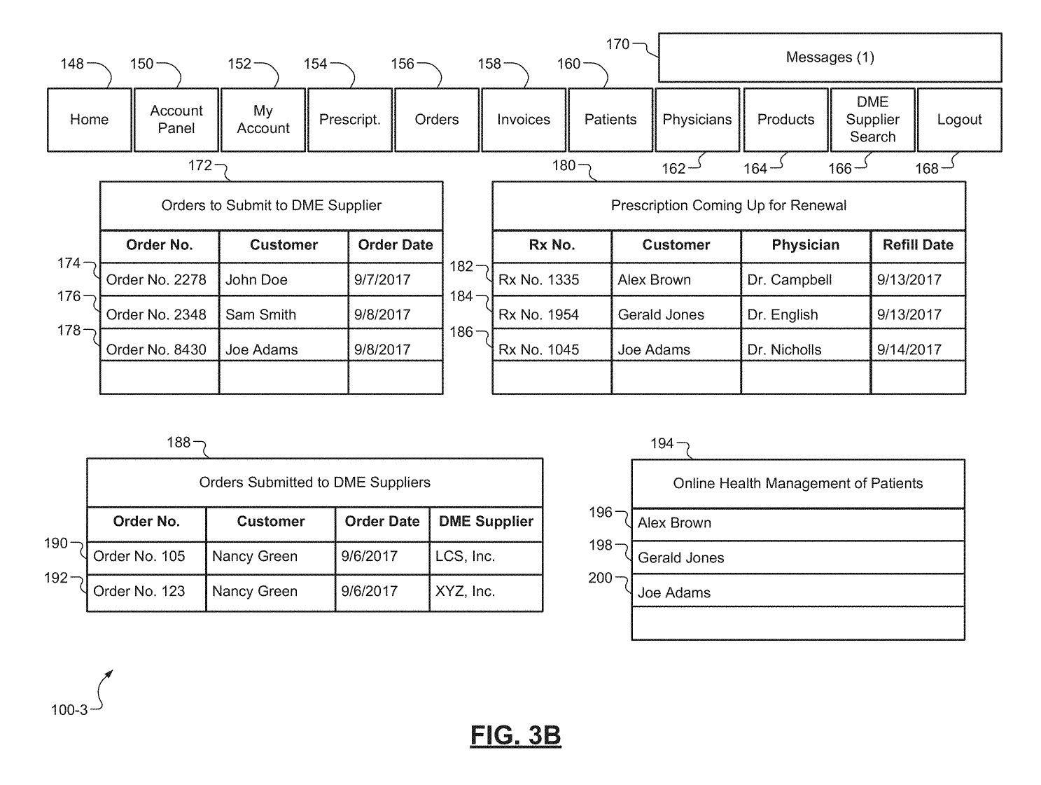

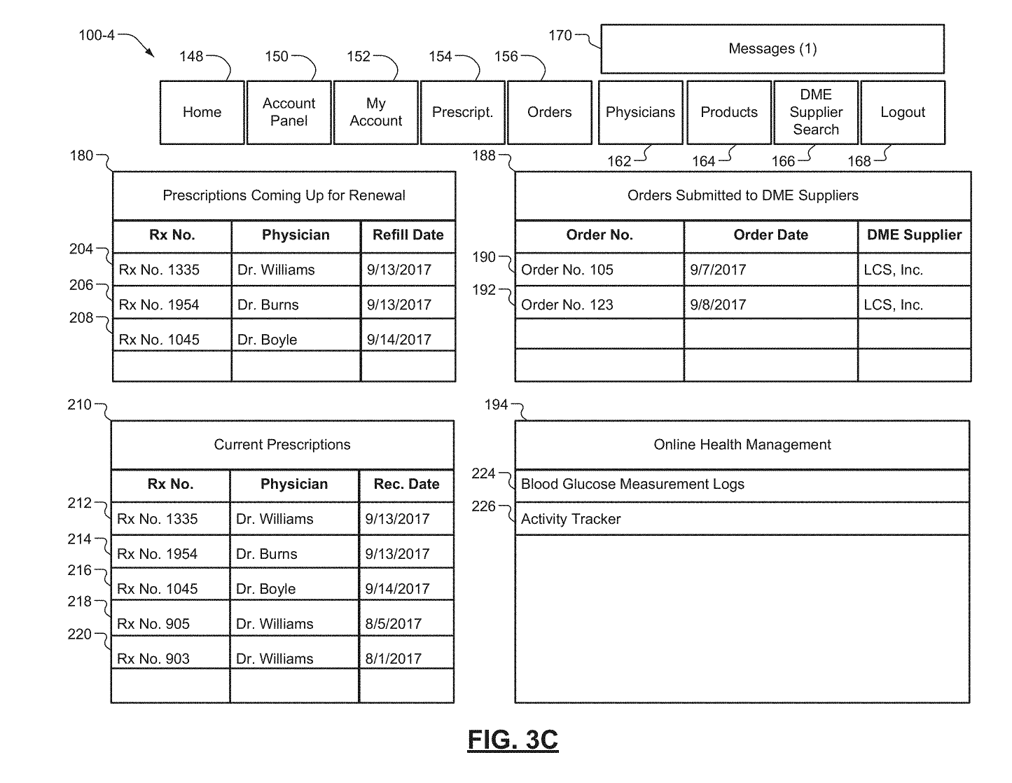

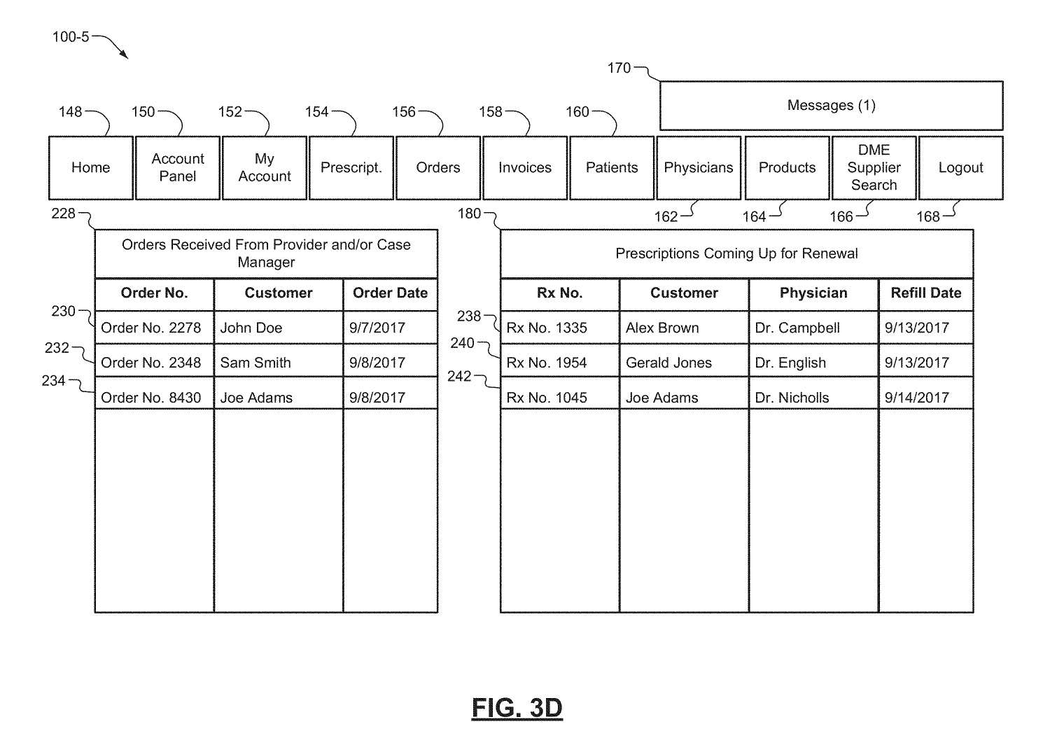

The patient 60, using the computing device, may search for durable medical equipment products that have been prescribed to the patient and/or access the patient's profile. As an example, in response to launching the App, the computing device may be configured to set the App to a default App state. The default App state, as described below in FIGS. 2A and 3A, may be configured to provide an interface on the computing device that allows the patient 60 to search for durable medical equipment suppliers 50 and/or access the patient's profile. Additionally or alternatively, the patient 60 may, in response to accessing the corresponding patient's profile, view their current prescriptions, generate prescription refill requests, track orders submitted to durable medical equipment suppliers, communicate with the case managers 30, healthcare providers 40, and/or durable medical equipment suppliers 50, and perform various online health management functions, as described below with reference to FIG. 3C.

The case manager 30 and the healthcare provider 40, using the computing devices, may also search for durable medical equipment products that have been prescribed to the patient 60 and access their respective profiles. Additionally or alternatively, in response to accessing the corresponding patient's profile, the case manager 30 and/or healthcare provider 40 may view orders that need to be submitted to a durable medical equipment supplier, view prescriptions that need to be renewed and/or refill prescriptions, track orders submitted to durable medical equipment suppliers, communicate with others on the healthcare management system 10, and view the online health management diagnostics of their respective patients 60, as described below with reference to FIG. 3B.

The durable medical equipment supplier 50, using the computing device, may review orders received from the case manager 30 and/or healthcare provider 40, view prescriptions that need to be renewed, process prescriptions for durable medical equipment, and communicate with others on the healthcare management system 10, as described below with reference to FIG. 3D. Furthermore, the durable medical equipment suppliers 50 may communicate information corresponding to the types of durable medical equipment they sell and/or currently have in their inventory and the types of private and/or federal health insurance they accept.

With reference to FIG. 2A, an illustration of an example default App state 100-1 of the App is shown. The App may be set to the default App state 100-1 when one of the case manager 30, healthcare provider 40, durable medical equipment supplier 50, and the patient 60 initiate the App on the computing device. The default App state 100-1 may include a login interface 102, which includes a username input 104, a password input 106, a login button 108, and a new profile button 110. The default App state 100-1 may also include a directory App state button 112.

The login interface 102 is configured to provide the user of the App a plurality of inputs and/or user-selectable links to access the user's profile. As an example, the user may input a username associated with the user in the username input 104, and the user may then input a corresponding password associated with the user in the password input 106. Specifically, when the user selects either the username input 104 or the password input 106, the App may be configured to load a keyboard on the computing device. Additionally or alternatively, the App may be configured to convert a voice input from the user into text when the user selects either the username input 104 or the password input 106. Once the user has inputted the username and password associated with the user's profile, the user may select the login button 108. In response to selecting the login button 108, the App is configured to transition to one of a patient profile App state, a healthcare provider/case manager profile App state, or a durable medical supplier profile App state, as described below with reference to FIGS. 3B-3D. If the user of the computing device does not have a profile stored on the healthcare management system 10, the user may select the new profile button 110 in order to create a profile and access the healthcare management system 10.

Additionally or alternatively, the user of the computing device may not need a profile in order to access certain App states of the App. As an example, the user may not need a profile in order to access a directory App state. In this embodiment and as shown by a cartoon hand, the user does not have a profile stored on the healthcare management system 10 and therefore selects the directory App state button 112. In response to selecting the directory App state button 112, the App is configured to transition to the directory App state, as described below with reference to FIGS. 2B-2D.

With reference to FIG. 2B, an example directory App state 100-2 of the App is shown. The App may be set to the directory App state 100-2 in response to the user selecting the directory App state button 112 of the default App state 100-1, as described in FIG. 2A. Additionally or alternatively, the App may be set to the directory App state 100-2 in response to the user selecting a durable medical equipment search button of the patient profile App state, the healthcare provider/case manager profile App state, or the durable medical supplier profile App state, as described below with reference to FIGS. 3B-3D.

The directory App state 100-2 may include the login interface 102, and a search parameter interface 114, which includes a location input 116, a product category input 118, a search radius input 120, a results input 122, a durable medical equipment provider input 124, and a search button 126. The product category input 118, the search radius input 120, the results input 122, and the durable medical equipment provide input 124 may each include respective chevrons 128, 130, 132, and 134. The directory App state 100-2 may also include a results interface 136, which includes a scrollbar 138, and the directory App state 100-2 may also include a mapping interface 140.

The location input 116 is configured to receive location parameters from the user. Specifically, when the user selects either the location input 116, the App may be configured to load a keyboard on the computing device. Additionally or alternatively, the App may be configured to convert a voice input from the user into text when the user selects the location input 116. Once the user has selected the location input 116, the user may input a location based on a city name or zip code. Additionally, the user may input the location based on locations associated with previous search queries that appear in an expanded list below the location input 116. The expanded list below the location input may be displayed in response to the user selecting the location input 116. Furthermore, the expanded list below the location input 116 may include an option corresponding to a current location of the user, which is based on GPS information received by a GPS receiver of the computing device.

The product category input 118 is configured to receive durable medical equipment product parameters from the user. As an example, in response to selecting chevron 128, which is associated with the product category input 118, the search parameter interface 114 is configured to display a list below the product category input 118 with various types of durable medical equipment products, as described below with reference to FIG. 2C.

The search radius input 120 is configured to receive a search radius parameter from the user. As an example, in response to selecting chevron 130, which is associated with the search radius input 120, the search parameter interface 114 is configured to display a list below the search radius input 120 with distances corresponding to the search radius (e.g., 5 miles, 10 miles, 20 miles, and 50 miles). Furthermore, in response to selecting a distance from the list below the search radius input 120, the App is subsequently configured to confine the radius of the durable medical equipment supplier search to the selected distance.

The results input 122 is configured to receive a number of desired results to be displayed on a single page of the directory App state 100-2. As an example, in response to selecting chevron 132, which is associated with the results input 122, the search parameter interface 114 is configured to display a list below the results input 122 with a number of search results to be displayed on the single page of the directory App state 100-2 (e.g., 10 results, 25 results, or 50 results).

The durable medical equipment provider input 124 is configured to receive at least one of a private and/or federal health insurance program from the user. As an example, in response to selecting chevron 134, which is associated with the durable medical equipment provider input 124, the search parameter interface 114 is configured to display a list below the durable medical equipment provider input 124 with various private and/or federal health insurance programs (e.g., Medicare).

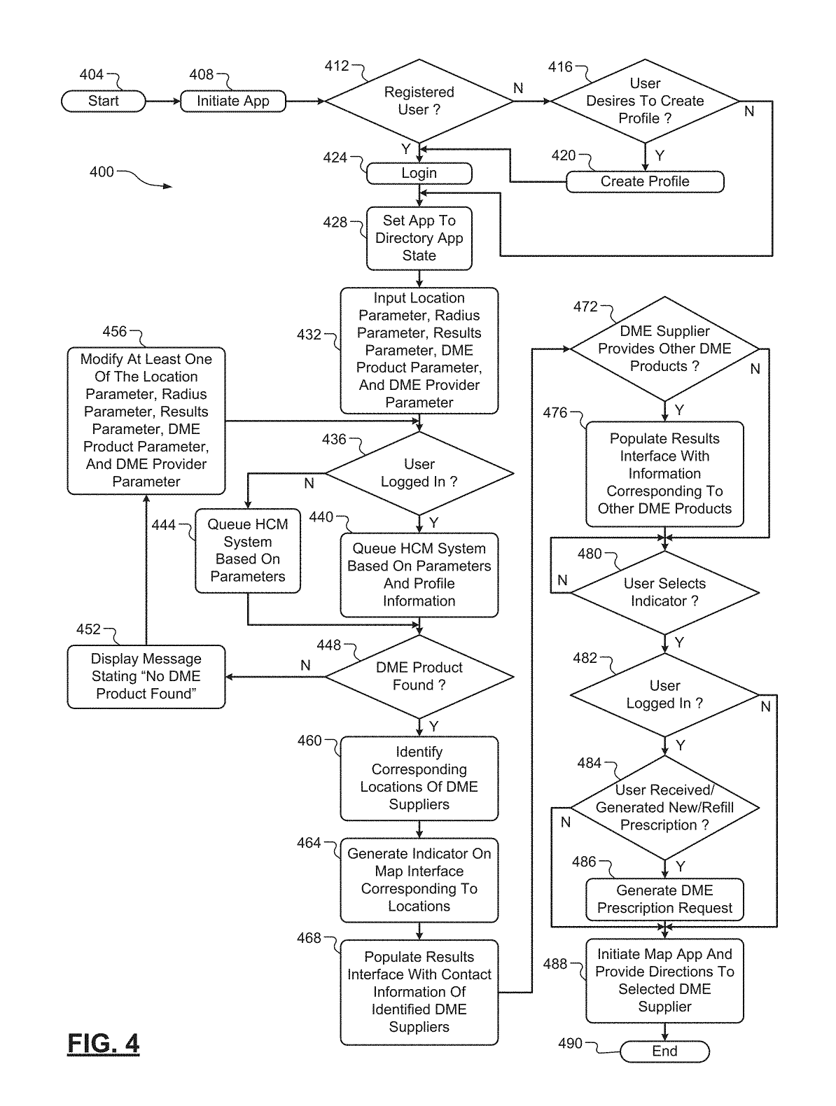

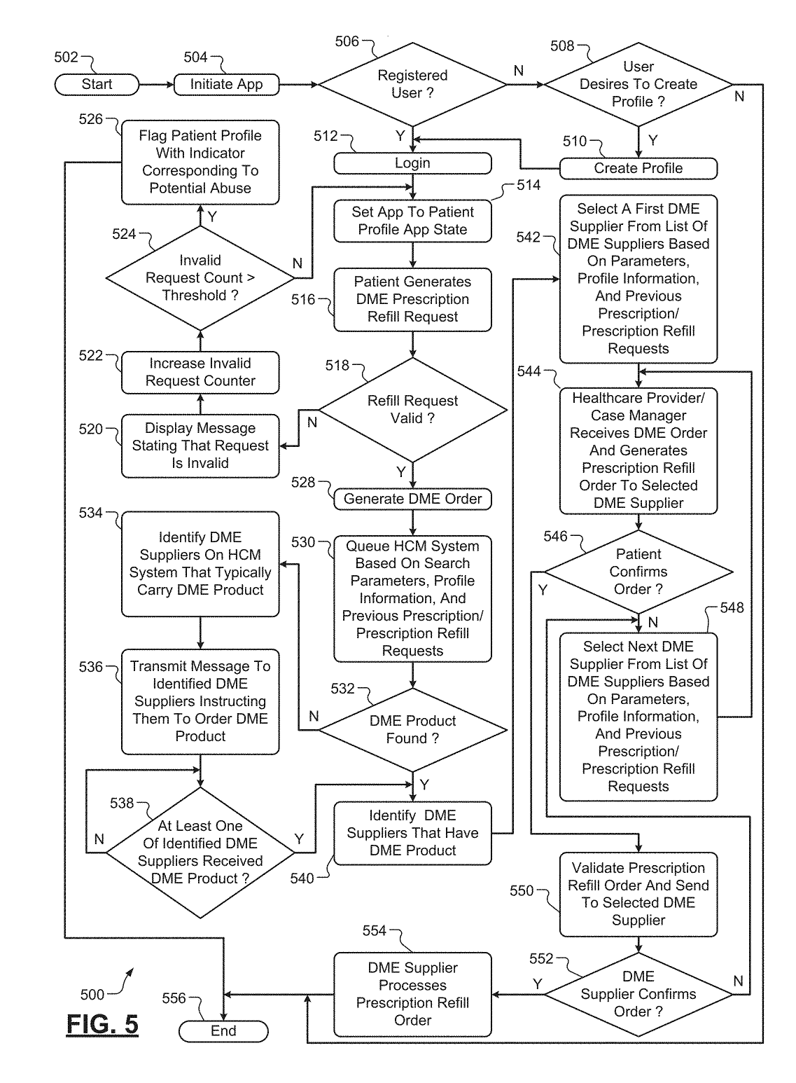

In response to selecting the search button 126, the App is configured to transmit a query to the healthcare management system 10 based on the search parameters of the location input 116, product category input 118, search radius input 120, the results input 122, and the durable medical equipment provider input 124. Subsequently, the healthcare management system 10 generates a list of durable medical equipment suppliers based on a matching of the query to the location, availability of selected durable medical equipment products, and the types of durable medical equipment providers accepted for each durable medical equipment supplier of the healthcare management system 10. The healthcare management system 10 then transmits the list of durable medical equipment suppliers to the computing device, as described below with reference to FIGS. 4-5. In response to receiving the list of durable medical equipment suppliers, the results interface 136 and the mapping interface 140 display information corresponding to the list of durable medical equipment suppliers, as described below with reference to FIG. 2D.

With reference to FIG. 2C, an example illustration of the directory App state 100-2 in response to a user input of chevron 128 is shown. Chevron 128, which is associated with the product category input 118, is configured to expand and provide a list of various types of durable medical equipment products in response to the user selecting the chevron 128. Furthermore, the list of the various types of durable medical equipment products may temporarily obscure other buttons and/or inputs on the login interface 102 and the search parameter input interface 114. Once the user selects a durable medical equipment product, the product category input 118 may update corresponding to the selection (e.g., display text corresponding to the selected durable medical equipment product) and then collapse the list of the various types of durable medical equipment, thereby making the obscured buttons and/or inputs visible again.

With reference to FIG. 2D, an example illustration of the directory App state 100-2 in response to the user performing search is shown. As shown in FIG. 2D, the user has input the zip code 48098 in the location input 116; the user has selected cochlear implants from the product category input 118; the user has designated the search radius as 50 miles in the search radius input 120; the user has designated the App to display 25 results per page in the results input 122; and the user has designated Medicaid as the durable medical equipment provider in the durable medical equipment provider input 124.

Once the user has finalized the search parameters, the user selects search button 126, and in response to selecting the search button 126, the directory App state 100-2 is configured to update the results interface 136 with information corresponding to the durable medical equipment suppliers that match the search parameters. The results interface 136 may include, for example, the name, address, and/or other contact information of the matched durable medical equipment supplier. Furthermore, the identified durable medical equipment suppliers may be listed in order of ascending distance from the user, and the user may select and drag the scrollbar 138 to view other identified durable medical equipment suppliers that match the search parameters.

Additionally or alternatively, the mapping interface 140 is configured to display a map and a plurality of destination indicators 144-1, 144-2, 144-3 that correspond to the location of the durable medical equipment suppliers that match the search parameters. The mapping interface 140 may also include a reference indicator 146 that corresponds to the location inputted in the location input 116. The matching of the search parameters and the durable medical equipment suppliers is described below with reference to FIG. 4.

With reference to FIG. 3A, an illustration of the example default App state 100-1 of the App is shown. FIG. 3A is identical to the default App state 100-1 of the App shown in FIG. 2A, except in this embodiment, the user has a profile stored on the healthcare management system 10. As shown by the login interface 102 and as indicated by the cartoon hand, the user has inputted the username “johnlewis123” in the username input 104 and the corresponding password in the password input 106. Provided that the login credentials match the login credentials in the healthcare management system 10 and based on the type of profile (e.g., patient profile), the App is configured to transition to one of the patient profile App state, the healthcare provider/case manager profile App state, or the durable medical supplier profile App state in response to the user selecting login button 108.

With reference to FIG. 3B, the healthcare provider/case manager profile App state 100-3 of the App is shown. The healthcare provider/case manager profile App state 100-3 may include a home button 148, an account panel button 150, an account button 152, a prescriptions button 154, an orders button 156, an invoices button 158, a patients button 160, a physicians button 162, a products button 164, a durable medical equipment supplier search button 166, a logout button 168, and a messages button 170. Additionally, the healthcare provider/case manager profile App state 100-3 may include a new orders interface 172, a prescription renewal interface 180, a completed orders interface 188, and an online health management interface 194.

The healthcare provider/case manager profile App state 100-3 is configured to provide a general overview of the healthcare provider/case manager's patients' prescriptions, orders, and prescriptions that need to be renewed. Furthermore, the account panel App state may provide links that, in response to being selected, are configured to provide a list of corresponding patients and their demographic information, other healthcare providers, prescriptions, and orders.

Additionally, the App is configured to transition to various App states in response to selecting the buttons. As an example, the App is configured to transition to a developer App state in response to selecting the home button 148, wherein the developer App state may be configured to provide general and contact information corresponding to the developer of the healthcare management system 10. As another example, the App is configured to transition to the healthcare provider/case manager profile App state 100-3 in response to selecting the account panel button 150 if the App is not in the healthcare provider/case manager profile App state 100-3.

As another example, the App is configured to transition to a prescription App state in response to selecting the prescriptions button 154, wherein the prescription App state is configured to provide an interface for the healthcare provider/case manager to prescribe, refill prescriptions, and/or view current prescriptions. As another example, the App is configured to transition to an orders App state in response to selecting the orders button 156, wherein the orders App state may be configured to provide information corresponding to present and/or past durable medical supply equipment orders.

As another example, the App is configured to transition to an invoice App state in response to selecting the invoices button 158, wherein the invoice App state provides an interface for the healthcare provider/case manager to view invoices associated with their patients. As another example, the App is configured to transition to the patient App state in response to selecting the patients button 160, wherein the patients App state is configured to provide an interface for the healthcare provider/case manager to view their patients and add new patients to their profile. Furthermore, the healthcare provider/case manager may be able to view their patients' online health management reports that may include, for example, activity tracking reports and blood glucose measurement reports.

As another example, the App is configured to transition to a physician App state in response to selecting the physicians button 162, wherein the physician App state is configured to provide an interface displaying other healthcare providers that are associated with their patients. As another example, the App is configured to transition to a products App state in response to selecting the products button 164, wherein the products App state is configured to provide an interface allowing healthcare providers/case managers to search for various durable medical equipment products. As another example, the App is configured to transition to the directory App state 100-2 in response to selecting the durable medical equipment supplier search button 166, wherein the directory App state 100-2 is configured to provide an interface allowing the healthcare provider/case manager to search for durable medical equipment supplies for their patients, as described above with reference to FIGS. 2B-2D.

As another example, the App is configured to transition to the default App state 100-1 in response to selecting the logout button 168, wherein the default App state 100-1 is configured to provide an interface allowing the healthcare provider/case manager to search for durable medical equipment suppliers and/or access their user profile, as described above with reference to FIG. 2A. As another example, the App is configured to transition to a messaging App state in response to selecting the messages button 170, wherein the messaging App state is configured to provide an interface allowing the healthcare provider/case manager to communicate with other healthcare providers, case managers, durable medical equipment suppliers, and their patients.

The new orders interface 172 may be configured to provide a portion of the interface that is displayed while the App is in the orders App state and/or prescriptions App state. As an example, the new orders interface 172 may include buttons 174, 176, 178 that, in response to being selected, cause the App to transition to the orders App state or the prescriptions App state and display an entry corresponding to an order number, a customer name, and an order date. Furthermore, the healthcare provider/case manager may be able to generate new prescriptions while in the orders App state or the prescriptions App state.

The completed orders interface 188 may be configured to provide a portion of the interface that is displayed while the App is in the orders App state, prescriptions App state, and/or invoices App state. As an example, the completed orders interface 188 may include buttons 190, 192 that, in response to being selected, cause the App to transition to the orders App state, the prescriptions App state, or the invoices App state and display an entry corresponding to an order number, a customer name, an order date, and a durable medical equipment supplier. Furthermore, the healthcare provider/case manager may be able to review and track orders of previous prescriptions and in response to selecting one of the buttons 190, 192.

The prescription renewal interface 180 may be configured to provide a portion of the interface that is displayed while the App is in the prescriptions App state. As an example, the prescription renewal interface 180 may include buttons 182, 184, 186 that, in response to being selected, cause the App to transition to the prescriptions App state and display an entry corresponding to a prescription number, a customer name, an associated healthcare provider, and a refill date. Furthermore, the healthcare provider/case manager may be able to renew or generate refill prescriptions while in the prescriptions App state.

The online health management interface 194 may be configured to provide a portion of the interface that is displayed while the App is in the patients App state. As an example, the online health management interface 194 may include buttons 196, 198, 200 that, in response to being selected, cause the App to transition to the patients App state and display an entry corresponding to the customer name. As described above, the healthcare provider/case manager may be able to view various health diagnostics that are associated with the corresponding patient, such as an activity tracking report and a blood glucose measurement report.

With reference to FIG. 3C, the patient profile App state 100-4 of the App is shown. The patient profile App state 100-4 may include the home button 148, the account panel button 150, the my account button 152, the prescriptions button 154, the orders button 156, the physicians button 162, the products button 164, the durable medical equipment supplier search button 166, the logout button 168, and the messages button 170. Additionally, the patient profile App state 100-4 may include the prescription renewal interface 180, the completed orders interface 188, the online health management interface 194, and a current prescription interface 210.

The prescription renewal interface 180 may be configured to provide a portion of the interface that is displayed while the App is in the prescriptions App state. As an example, the prescription renewal interface 180 may include buttons 204, 206, 208 that, in response to being selected, cause the App to transition to the prescriptions App state and display an entry corresponding to a prescription number, a healthcare provider's name, and a refill date. Furthermore, the patient may be able to generate prescription refill requests while in the prescriptions App state.

The completed orders interface 188 may be configured to provide a portion of the interface that is displayed while the App is in the orders App state, prescriptions App state, and/or invoices App state. As an example, the completed orders interface 188 may include buttons 190, 192 that, in response to being selected, cause the App to transition to the orders App state, the prescriptions App state, or the invoices App state and display an entry corresponding to an order number, an order date, and a durable medical equipment supplier. Furthermore, the patient may be able to review and track orders of previous prescriptions while in one of the orders App state, the prescriptions App state, or the invoices App state.

The online health management interface 194 may be configured to provide a portion of the interface that is displayed while the App is in a personal account App state. As an example, the online health management interface 194 may include buttons 224, 226 that, in response to being selected, cause the App to transition to the personal account App state and display an entry corresponding to patient's various health diagnostics, such as an activity tracking report and a blood glucose measurement report of the patient.

The current prescription interface 210 may be configured to provide a portion of the interface that is displayed while the App is in the account App state. The App may transition to the account App state in response to the patient selecting the my account button 152. As an example, the current prescription interface 210 may include buttons 212, 214, 216, 218, 220 that, in response to being selected, cause the App to transition to the account app state and display a data entry corresponding to the prescription number, prescribing healthcare provider, and the date the prescription was received.

With reference to FIG. 3D, a durable medical equipment supplier profile App state 100-5 of the App is shown. The durable medical equipment supplier App state 100-5 may include the home button 148, the account panel button 150, the my account button 152, the prescriptions button 154, the orders button 156, the invoices button 158, the patients button 160, the physicians button 162, the products button 164, the durable medical equipment supplier search button 166, the logout button 168, and the messages button 170. Additionally, the durable medical equipment supplier App state 100-5 may include the prescription renewal interface 180 and a received orders interface 228.

The prescription renewal interface 180 may be configured to provide a portion of the interface that is displayed while the App is in the prescriptions App state. As an example, the prescription renewal interface 180 may include buttons 238, 240, 240 that, in response to being selected, cause the App to transition to the prescriptions App state and display an entry corresponding to a prescription number, a customer name, an associated healthcare provider, and a refill date. Furthermore, the durable medical equipment supplier may be able to provide status updates regarding these orders (e.g., order tracking information) while in the prescriptions App state.

The received orders interface 228 may be configured to provide a portion of the interface that is displayed while the App is in the orders App state. As an example, the received orders interface 228 may include buttons 230, 232, 234 that, in response to being selected, cause the App to transition to the orders App state and display an entry corresponding to an order number, a customer name, and an order date. Furthermore, the durable medical equipment supplier may be able to provide status updates regarding these orders (e.g., order process confirmation) while in the orders App state.

With reference to FIG. 4, a flowchart illustrating an example control algorithm 400 of the durable medical equipment search system is shown. The control algorithm 400 starts at 404 when, for example, a user (i.e., one of the case manager 30, healthcare provider 40, durable medical equipment supplier 50, and the patient 60) turns on their respective computing device. At 408, the control algorithm 400 initiates the App. At 412, the control algorithm 400 determines whether the user is a registered user of the healthcare management system 10. If so, the control algorithm 400 proceeds to 424; otherwise, the control algorithm 400 proceeds to 416. At 416, the control algorithm 400 determines whether the user desires to create and register a user profile for the healthcare management system 10. The durable medical equipment search system may be able to provide more personalized search results corresponding to the user profile if the user creates a profile and registers with the healthcare management system 10, as the search results may be generated based in part on the user profile settings. If the user desires to create a profile, the control algorithm 400 proceeds to 420; otherwise, the control algorithm 400 proceeds to 428.

At 420, the control algorithm 400 creates a user profile for the user. As an example, the App may transition to a new profile App state that enables a user to create a profile based on, for example, their personal and/or contact information, private and/or federal health insurance information, etc. The control algorithm 400 then proceeds to 424, wherein the user accesses their corresponding profile of the healthcare management system 10 by logging in.

At 428, the control algorithm 400 sets the App to the directory App state. At the directory App state, the App may provide an interface that enables the user to enter various search parameters, as described above with reference to FIGS. 2A-2C. At 432, the control algorithm 400 receives inputs from the user corresponding to the various search parameters including, but not limited to, location parameters, radius parameters, results parameters, durable medical equipment product parameters, and durable medical equipment provider parameters.

At 436, the control algorithm 400 determines whether the user is logged into the healthcare management system 10. If so, the control algorithm 400 proceeds to 440 and queues the healthcare management system 10 based on the search parameters and the information associated with the user profile. Otherwise, the control algorithm 400 proceeds to 444 and queues the healthcare management system 10 based on the search parameters.

At 448, the control algorithm 400 determines whether a durable medical equipment product corresponding to the query is found. If so, the control algorithm 400 proceeds to 460; otherwise, the control algorithm 400 proceeds to 452. At 452, the control algorithm 400 may, using the App, display a message in the directory App state stating “No DME Product Was Found,” and then proceed to 456. At 456, the control algorithm 400 may receive a second input corresponding to modified search parameters including, but not limited to, location parameters, radius parameters, results parameters, durable medical equipment product parameters, and durable medical equipment provider parameters. The control algorithm 400 then returns to 436.

At 460, the control algorithm 400 identifies the corresponding locations of the durable medical equipment suppliers that have been identified based on the query. At 464, the control algorithm 400 generates an indicator on the map interface of the directory App state corresponding to the locations of the identified durable medical equipment suppliers. At 468, the control algorithm populates the results interface of the directory App state with contact information of the identified durable medical equipment suppliers. As an example, the contact information may include the name, address, phone number, and email address of the identified durable medical equipment supplier, as described above with reference to FIG. 2D.

At 472, the control algorithm 400 determines whether the durable medical equipment supplier provides other durable medical equipment products that were not included in the durable medical equipment product parameters. If so, the control algorithm 400 proceeds to 476; otherwise, the control algorithm 400 proceeds to 480. At 476, the control algorithm 400 populates the results interface of the directory App state with information corresponding to other types of durable medical equipment products that the durable medical equipment supplier provides, as shown in FIG. 2C.

At 480, the control algorithm 400 determines whether the user has selected an indicator on the map interface of the directory App state. If so, the control algorithm 400 proceeds to 482; otherwise, the control algorithm 400 remains at 480 until the user selects an indicator on the map interface of the directory App state. At 482, the control algorithm 400 determines whether the user is logged into the healthcare management system 10. If so, the control algorithm 400 proceeds to 484; otherwise, the control algorithm proceeds to 488. At 484, the control algorithm 400 determines whether the user has received or generated a new prescription request or a prescription refill request. If so, the control algorithm 400 proceeds to 486; otherwise, the control algorithm 400 proceeds to 488.

At 486, the control algorithm 400 generates, using the App, a durable medical equipment prescription request. As an example, if the user is a patient, the user may upload their prescription to the healthcare management system 10 by scanning and uploading the prescription to the healthcare management system 10; or capturing an image of the prescription and uploading the prescription to the healthcare management system 10. As another example, if the user is a healthcare provider or a case manager, the user may upload the patient's prescription to the healthcare management system 10 by generating an electronic prescription on the healthcare management system 10; scanning and uploading the prescription to the healthcare management system 10; or capturing an image of the prescription and uploading the prescription to the healthcare management system 10.

At 488, the control algorithm 490 may, using the computing device, initiate a map App, (e.g., Google Maps®, Apple Maps®, Yahoo! Maps®, Windows Live Search Maps®, etc.) and input the location information of the identified durable medical equipment supplier into the search parameters of the map App. Accordingly, the map App may subsequently be configured to provide driving directions to the user. The control algorithm 400 ends at 490.

With reference to FIG. 5, a flowchart illustrating an example control algorithm 500 for generating prescriptions and prescription refills of the healthcare management system 10 is shown. The control algorithm 500 starts at 502 when, for example, a user (i.e., one of the case manager 30, healthcare provider 40, durable medical equipment supplier 50, and the patient 60) turns on their respective computing device. At 504, the control algorithm 500 initiates the App. At 506, the control algorithm 500 determines whether the user is a registered user of the healthcare management system 10. If so, the control algorithm 500 proceeds to 512; otherwise, the control algorithm 500 proceeds to 508. At 508, the control algorithm 500 determines whether the user desires to create and register a user profile for the healthcare management system 10. If the user desires to create a profile, the control algorithm 500 proceeds to 510; otherwise, the control algorithm 500 proceeds to 556 and ends.

At 510, the control algorithm 500 creates a user profile for the user. As an example, the App may transition to a new profile App state that enables a user to create a profile based on, for example, their personal and/or contact information, private and/or federal health insurance information, etc. The control algorithm 500 then proceeds to 512, wherein the user accesses their corresponding profile of the healthcare management system 10 by logging in.

At 514, the control algorithm 500 sets the App to the patient profile App state. At the patient App state, the App may provide an interface that may enable the patient to view current and new prescriptions, generate prescriptions and/or prescription refill requests, view prescription orders, view physicians, view durable medical equipment products, and access the directory App state, as described above with reference to FIG. 3B.

At 516, the control algorithm may generate a durable medical equipment prescription refill request when, for example, the patient has run out of prescribed durable medical equipment. At 518, the control algorithm 500 determines whether the refill request is valid. As an example, the control algorithm 500 may determine that a refill request is valid if it falls within a set of dates corresponding to when the original prescription durable medical equipment should be depleted. If the durable medical equipment prescription refill request is valid, the control algorithm 500 proceeds to 528; otherwise, the control algorithm 500 proceeds to 520.

At 520, the control algorithm 500 may display, using the App, a message on the computing device stating that the durable medical equipment prescription refill request is invalid. At 522, the control algorithm 500 may increase an invalid request counter by one. The invalid request counter may be a metric that is configured to detect whether the patient is abusing prescribed durable medical equipment. Accordingly, at 524, the control algorithm 500 is configured to determine whether the invalid request count is greater than a count threshold, wherein the count threshold is indicative of potential abuse of the prescribed durable medical equipment. If so, the control algorithm proceeds to 526; otherwise, the control algorithm 500 returns to 514. At 526, the control algorithm 500 flags the patient profile with an indicator corresponding to potential abuse. Additionally or alternatively, the healthcare management system 10 may be configured to transmit a message to the case manager 30 and/or healthcare provider 40 with information corresponding to the patient's potential abuse of the durable medical equipment. The control algorithm 500 then ends at 556.

At 528, the control algorithm 500 generates a durable medical equipment order corresponding to the durable medical equipment prescription refill request. In other words, the healthcare management system 10 may generate a query corresponding to the durable medical equipment prescription refill request. At 530, the control algorithm 500 transmits the query, and the control algorithm 500 queues the healthcare management system 10 based on the search parameters (e.g., location parameters, radius parameters, results parameters, and durable medical equipment product parameters), profile information (e.g., address of the user, private and/or federal health insurance provider, etc.), and previous prescription and/or prescription refill requests (e.g., query may include information corresponding to patient obtaining multiple prescription refills from a single durable medical equipment supplier).

At 532, the control algorithm 500 determines whether the durable medical equipment product corresponding to the query is found. If so, the control algorithm 500 proceeds to 540; otherwise, the control algorithm 500 proceeds to 534. At 534, the control algorithm 500 identifies durable medical equipment suppliers on the healthcare management system 10 that typically carry the durable medical equipment product. At 536, the healthcare management system 10 transmits a message to the identified durable medical equipment suppliers with instructions to order the durable medical equipment product. At 538, the control algorithm 500 determines whether at least one of the identified durable medical equipment suppliers received the durable medical equipment product. If so, the control algorithm 500 proceeds to 540; otherwise, the control algorithm 500 remains at 538 until at least one of the identified durable medical equipment suppliers receives the durable medical equipment product.

At 540, the control algorithm 500 identifies the durable medical equipment suppliers of the healthcare management system 10 that have the durable medical equipment product. At 542, the control algorithm 500 selects a first durable medical equipment supplier from a list of durable medical equipment suppliers based on the search parameters and previous prescription and/or prescription refill requests. At 544, the healthcare provider and/or case manager receives the durable medical equipment order and information corresponding to the selected durable medical equipment supplier, and then generates a prescription refill order to the selected durable medical equipment supplier.

At 546, the control algorithm 500 determines whether the patient confirms the prescription refill. As an example, the patient may prefer to obtain the durable medical equipment from a different durable medical equipment supplier than the selected durable medical equipment supplier. If the patient confirms the order, the control algorithm 500 proceeds to 550; otherwise, the control algorithm 500 proceeds to 548. At 548, the control algorithm 500 selects the next durable medical equipment supplier from the list of durable medical equipment suppliers based on the search parameters, and previous prescription and/or prescription refill requests. The control algorithm 500 then returns to 544. At 550, the control algorithm 500 validates the prescription refill order and then sends it to the selected durable medical equipment supplier. At 552, the control algorithm 500 determines whether the selected DME supplier confirms the prescription refill order. If so, the control algorithm 500 proceeds to 554; otherwise, the control algorithm 500 returns to 548. At 554, the selected DME supplier processes the prescription refill order. The control algorithm 500 ends at 556.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

What is claimed is:

1. A method of durable medical equipment (DME) searching and management, the method comprising:
receiving, using a processor that is configured to execute instructions stored in a non-transitory memory, input parameters corresponding to (i) a location, (ii) a DME product, and (iii) a DME provider;
transmitting, using the processor, a query based on the input parameters;
receiving, using the processor, a set of search results based on the query, wherein the set of search results includes at least one DME supplier and is generated based on a matching of the query and the at least one DME supplier; and
displaying, using the processor, the set of search results.

2. The method of claim 1 further comprising:
identifying, using the processor, corresponding locations of the at least one DME supplier;
generating, using the processor, an indicator for one of the at least one DME supplier; and
generating, using the processor, a reference indicator corresponding to the input parameter corresponding to the location.

3. The method of claim 2 further comprising generating, using the processor, a mapping interface based on the indicator and the reference indicator.

4. The method of claim 2 further comprising generating, using the processor, driving instructions based on the input parameter corresponding to the location and the corresponding locations of the at least one DME supplier.

5. The method of claim 1 further comprising generating, using the processor, indicia based on the set of search results, wherein the indicia includes a name of the at least one DME supplier.

6. The method of claim 5, wherein the indicia includes at least one of contact information associated with the at least one DME supplier and a second DME product associated with the at least one DME supplier.

7. The method of claim 1 further comprising generating, using the processor, at least one of a prescription request and a prescription refill request based on a user profile and a selected DME supplier from the at least one DME supplier.

8. The method of claim 1, wherein the DME provider is at least one of a private health insurance company and a federal insurance program.

9. A system of durable medical equipment (DME) searching and management, the system comprising:
a processor that is configured to execute instructions stored in a non-transitory memory, wherein the instructions include:
receiving, using the processor, input parameters corresponding to (i) a location, (ii) a DME product, and (iii) a DME provider;
transmitting, using the processor, a query based on the input parameters;
receiving, using the processor, a set of search results based on the query, wherein the set of search results includes at least one DME supplier and is generated based on a matching of the query and the at least one DME supplier; and
displaying, using the processor, the set of search results.

10. The system of claim 9, wherein the instructions further comprise:
identifying, using the processor, corresponding locations of the at least one DME supplier;
generating, using the processor, an indicator for one of the at least one DME supplier; and
generating, using the processor, a reference indicator corresponding to the input parameter corresponding to the location.

11. The system of claim 10, wherein the instructions further comprise generating, using the processor, a mapping interface based on the indicator and the reference indicator.

12. The system of claim 10 wherein the instructions further comprise generating, using the processor, a driving instructions based on the input parameter corresponding to the location and the corresponding locations of the at least one DME supplier.

13. The system of claim 9 wherein the instructions further comprise generating, using the processor, indicia based on the set of search results, wherein the indicia includes a name of the at least one DME supplier.

14. The system of claim 13, wherein the indicia includes at least one of contact information associated with the at least one DME supplier and a second DME product associated with the at least one DME supplier.

15. The system of claim 9 wherein the instructions further comprise generating, using the processor, at least one of a prescription request and a prescription refill request based on a user profile and a selected DME supplier from the at least one DME supplier.

16. The system of claim 9, wherein the DME provider is at least one of a private health insurance company and a federal insurance program.

17. A system of durable medical equipment (DME) searching and management system, the system comprising:
a processor that is configured to execute instructions stored on a non-transitory memory component, wherein the instructions include:
receiving, using the processor, a DME request, wherein the DME request is at least one of a prescription request and a prescription refill request, and wherein the DME request is generated by at least one of a patient profile, healthcare provider profile, and a case manager profile;
identifying, using the processor, the patient profile associated with the DME request;
generating, using the processor, a DME order based on the DME request and the patient profile associated with the DME request;
generating, using the processor, a set of search results based on the DME order, wherein the set of search results includes at least one DME supplier from a list of DME suppliers, and the set of search results is based on at least one of (i) search parameters associated with the DME request, (ii) profile information associated with the patient profile, and (iii) a previous DME request associated with the patient profile;
selecting, using the processor, a first DME supplier of the at least one DME supplier, wherein the first DME supplier is selected based on a matching of the first DME supplier and the DME order; and
transmitting, using the processor, the DME order to the first DME supplier.

18. The system of claim 17, wherein the search parameters associated with the DME request include at least one of a location associated with the patient profile and a DME product.

19. The system of claim 18, wherein the matching is based on at least one of (i) the location associated with the patient profile, (ii) the DME product, and (iii) a DME provider associated with the patient profile.

20. The system of claim 18, wherein the instructions include transmitting, using the processor and in response to each of the DME suppliers of the list of DME suppliers not having the DME product, a message to the list of DME suppliers with instructions to order the DME product.
